(19) United States
(12) Patent Application Publication
(10) Pub. No.: US 2005/0067333 A1
(43) Pub. Date: Mar. 31, 2005

(54) Method and apparatus for detecting a cracked or broken case

(75) Inventors: Helmut Grollitsch, Houston, TX (US); Burkhard Lickfett, Houston, TX (US)

Correspondence Address: John S. Egbert;Harrison & Egbert, 7th Floor, 412 Main Street, Houston, TX, 77002, US

(73) Assignee: UNITECH, Inc., Houston, TX (US)

(21) Appl. No.: 10/672,402

(22) Filed: Sep. 29, 2003

(51) Int. Cl. B07C 5/34; B07C 9/00

(52) U.S. Cl. 209/599; 209/651; 209/656

(57) ABSTRACT

An apparatus for detecting a cracked or broken case has a frame, a conveyor means mounted on the frame, and a ram affixed to the frame for applying a force onto a surface of a wall of the case. A sensor is cooperative with the ram for detecting when the surface of the wall of the case has deflected beyond a desired amount. An ejector is affixed to the frame for removing the case from the conveyor when the sensor has detected that the wall of the case has deflected beyond the desired amount.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to devices for determining the quality of a container or case. More particularly, the present invention relates to the inspection of cases that can contain a plurality of fluid containers therein. Additionally, the present invention relates to quality control apparatus which utilize deflection techniques to determine the existence of a cracked or broken condition in the object being controlled.

### BACKGROUND OF THE INVENTION

Cases and containers are often used for the-transport of various objects from one location to another. In certain industries, it is a quite common practice to place a plurality of fluid containers such as milk bottles, soft drink bottles, alcoholic beverage containers, and other fluid containers within a single case. One type of case that is commonly employed is an injection-molded polymeric case having lattice walls. The bottom of the case is a closed surface. The open end of the case is positioned opposite the closed end. The lattice walls extend between the closed end and the open end. A plurality of dividers are often used interior of the case so as to provide compartments into which to insert the various fluid containers.

In practice, it quite common to stack these cases one upon another. Often the stacks can extend up to six feet in height. It is quite common to place a large number of the cases in a stacked configurations onto pallets. As a result, a forklift, or other transport vehicle, can be used so as to move the pallet, along with the stacked cases, from one location to another. Additionally, these cases are often stacked in very large quantities within the interior of a transport truck.

Unfortunately, given the generally rough handling conditions for these cases, it is very common for a surface of the case to become cracked or otherwise damaged. Unfortunately, because of the stacked nature of the transported cases, when a cracked condition occurs, there is a strong possibility that the crack will split and cause the rupture of one of the lattice walls of the case. Any cases that are stacked upon the ruptured case have the potential for tilting or falling. As a result, the damaged lower case not only can cause the destruction of the fluid containers within in such case, but can also result in a collapse of a stacked arrangement of cases. The result is not only the loss of the case, but also the products that are retained within the cases. A great deal of labor is also required in order to repair the damage associated with the collapsed stack of cases. Experiments with the cases of this type have shown that there are approximately 30 broken cases out of every 7,000 units.

Because of the nature of these polymeric injection-molded cases, it is very difficult to visually see when a crack or split has occurred in one of the lattice walls of the case. The lattice nature of the walls of the case further obscures the ability to see a split. Visual inspection is generally inadequate in determining whether or not damage has occurred to the case. Manipulation by hand may determine if the case is damaged, but manual manipulation is a lengthy and time consuming operation. Additionally, the strength that must be applied to determine whether a crack or split in the case has occurred may not be sufficient so as to properly indicate the damaged case. As such, a mechanical and automated technique is desired in order to determine whether or not a particular case has been damaged or defective.

In the past, various patent have issued relating to devices for detecting the integrity of containers. For example, U.S. Pat. No. 4,984,409, issued on Jan. 15, 1991 to H. Focke, describes a process and apparatus for the testing of carton packs, such as those made of corrugated cardboard. The device applies pressure onto one of the adhesively connected walls, such as the bottom wall and the cover wall. The device is used so as to detect inadequate connections between the walls through the springing open of the respective walls. The change of shape in the carton pack is detected by sensors, such as photosensors. Any faulty packs are separated out of the feedstream, put in order, and reintroduced into the stream. Pressure is applied solely to the top of the carton pack so as to determine whether the carton pack will withstand the application of pressure thereto.

U.S. Pat. No. 6,088,995, issued on Jul. 18, 2000 to Robinson et al., teaches another type of carton inspection and ejection system along a conveyor belt. The system is utilized to determine whether the carton has assumed a predetermined configuration at a predetermined point along the path of travel. Rollers are provided which are actuated to eject a carton when the detection elements determine that the carton element has not assumed the predetermined configuration.

U.S. Pat. No. 6,237,431 (issued on May 29, 2001 to R. Franke), U.S. Pat. No. 3,955,408 (issued on May 11, 1976 to J. D. Northup), U.S. Pat. No. 4,530,246 (issued on Jul. 23, 1985 to Pitman et al.), and U.S. Pat. No. 6,473,169 (issued on Oct. 29, 2002 to Dawley et al.) teach various container testing systems for use on a conveyor line. Each of these systems relies on the application of pressure to a plastic container so as to determine if a suitable deformation has occurred. U.S. Pat. No. 6,237,431 is used to detect defects in the glass material of hollow glass bodies. U.S. Pat. No. 3,955,408 describes a bottle testing device in which pressures are applied to the neck of the bottle and to the sides of the bottle. U.S. Pat. No. 4,530,246 is another device for applying forces to a glass article so as to determine whether a crack has formed in the glass article. U.S. Pat. No. 6,473,169 describes a pressure system for the inspection of bottles and other containers.

U.S. Pat. No. 6,474,141, issued on Nov. 5, 2002 to Takaoka et al., describes a seal inspection machine for inspecting bagged products to determine the presence or absence of a seal abnormality being transported along a conveyor belt.

It is an object of the present invention to provide an apparatus and a method for determining and inspecting cracked or broken cases.

It is another object of the present invention to provide a method and an apparatus whereby a broken case can be removed from a feedstream of cases.

It is another object of the present invention to provide a method and an apparatus which prevents the damage resulting from the stacking of cases upon a damaged or broken case.

It is a further object of the present invention to provide a method and an apparatus for inspecting lattice wall polymeric cases which ascertains the quality of the particular case.

It is still a further object of the present invention to provide a method and an apparatus which is easy to use, relatively inexpensive and easy to implement.

These and other objects and advantages of the present invention will become apparent from a reading of the attached specification and appended claims.

### BRIEF SUMMARY OF THE INVENTION

The present invention is an apparatus for detecting a cracked or broken case comprising a frame, a conveyor means mounted on the frame for the moving the case along the frame, and a first ram means affixed to the frame for applying a force onto a surface of a wall of the case. A sensor means is cooperative with the first ram means. This sensor means detects when the surface of the wall of the case has deflected beyond a desired amount. An ejection means is affixed to the frame and cooperative with the conveyor for removing the case from the conveyor when the wall of the case has deflected beyond the desired amount. A second ram means can also be affixed to the frame and positioned in a different location on the frame than the first ram means. The second ram means is suitable for applying a force onto another surface of the case.

In the present invention, the first ram means comprises a pneumatic ram having a cylinder affixed to the frame. The pneumatic ram has a piston extending outwardly therefrom. An arm is pivotally connected to the piston and pivotally connected to the frame so as to apply a leveraged force onto the wall of the case. The piston is movable between a first position and a second position relative to the cylinder. The first position causes the arm to be positioned away from the wall of the case. The second position urges the wall of the case outwardly. The sensor means is connected to the cylinder and cooperative with the piston for determining when the second position is beyond a desired amount of movement.

In the present invention, the second ram means is also a pneumatic ram having a cylinder affixed to the ram and a piston extending outwardly of the cylinder. The piston is movable between a first position and second position relative to the cylinder. The first position causes the arm to be positioned away from the other surface of the case. The second position urges the other surface of the case inwardly. In particular, this second ram means can be applied to the closed bottom of the case. The piston associated with the second ram means has a roller rotatably positioned at the end of the piston opposite the cylinder.

In the present invention, the ejection means is also a pneumatic ram having a cylinder affixed to the frame. The pneumatic ram has a piston extending outwardly therefrom. This piston is movable between a first position and second position relative to the cylinder. The first position is positioned away from another wall of the case. The second position serves to eject the case from the conveyor means. A positioning means is affixed to the frame for fixing a portion of the case relative to the frame. Additionally, a separating means is affixed to the frame in spaced relationship to the positioning means. The separating means serves to space another case from the case on the conveyor when the positioning means fixes the position of the case.

The present invention is also a method for detecting a cracked or broken case comprising the steps of: (1) fixing a position of the case; (2) applying a force against one of the plurality of walls of the case such that the wall deflects; and (3) determining whether the deflection of the wall is beyond a desired amount.

In this method, the step of applying the force includes positioning a surface of a ram against the wall of the case and actuating the ram such that the surface of the ram urges against the wall. The amount of the movement of the surface of the ram is then sensed so as to determine whether the deflection of the wall is beyond a desired amount. In particular, the piston associated with the ram is retracted so that the arm that is pivotally connected thereto exerts a leveraged force against the wall of the case.

In this method, there is formed a frame having a conveyor thereon and the case is conveyed along the frame prior to the step of fixing the position of the case. In order to fix the position of the case, a pneumatic ram is actuated such that a piston of the ram extends through the open side of the case and abuts one of the plurality of walls so as to stop the movement of the case relative to the conveyor. The case can be ejected when the deflection of the wall is beyond a desired amount. Another force can be applied against the closed side of the case such that the closed side deflects. Another sensor will determine whether the deflection of the closed side of the case is beyond a predetermined limit. The case is placed on the conveyor such that the open side of the case faces the conveyor and the closed bottom end of the case is actually in the uppermost position.

### BRIEF DESCRIPTION OF THE SEVERAL VIEWS OF THE DRAWINGS

FIG. 1 is a diagrammatic perspective view showing the method and apparatus in accordance with the preferred embodiment of the present invention.

FIG. 2 is a front view of the apparatus in accordance with the teachings of the present invention.

FIG. 3 is a top plan view of the apparatus of the present invention.

FIG. 4 is a side view of the apparatus of the present invention.

FIG. 5 is an opposite side view of the apparatus of the present invention.

### DETAILED DESCRIPTION OF THE INVENTION

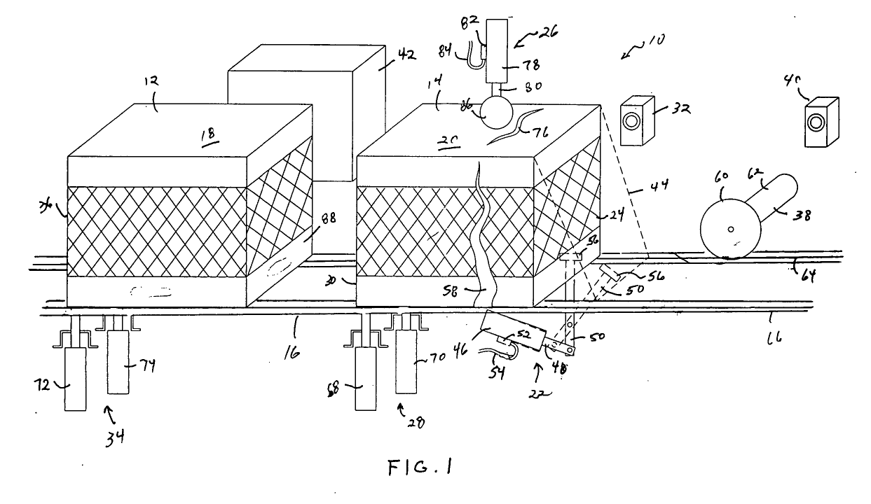

Referring to FIG. 1, there is shown the apparatus 10 of the present invention for detecting a cracked or broken case. In particular, in FIG. 1, it can be seen that cases 12 and 14 are in the nature of polymeric lattice-wall cases commonly used for the shipment of milk bottle, soft drinks and related liquid containers. The cases 12 and 14 are positioned on a conveyor 16 such that the open top end of the case 12 and 14 faces downwardly upon the conveyor 16. The closed bottom ends 18 and 20 of the cases 12 and 14, respectively, face upwardly when the cases 12 and 14 are positioned on the conveyor 16. Case 14 is illustrated in a proper position for inspection and detection. Case 12 is positioned behind case 14 in a staging position prior to testing.

In the present invention, a first ram 22 is positioned adjacent to the forward wall 24 of case 14. A second ram 26 is positioned adjacent to the closed bottom surface 20 of the case 14. Case positioning brakes 28 are arranged so as to be generally adjacent to the end wall 30 of case 14. An infrared positioning sensor 32 is directed generally transversely to the direction of the conveyor 16 and is directed toward the forward wall 24 of case 14. The case 12 is positioned in generally spaced relationship to the case 14 on the conveyor 16. Case separator brakes 34 are positioned generally adjacent to the back wall 36 of case 12. The case separator brakes 34 serve to retain the case 12 in spaced relationship to the case 14.

A broken case ejector 38 is arranged relative to the conveyor 16 and positioned so as to remove any broken cases passing thereby from the conveyor 16. An infrared positioning sensor 40 is positioned adjacent to the ejector 34 so as to indicate when the broken case is positioned in proximity to the ejector 38. A programmable logic controller 42 is cooperative with each of the elements of the apparatus 10. The programmable logic controller will provide an indication when the first ram 22 has caused the wall 24 to deflect outwardly beyond a predetermined limit (as shown by the broken lines 44 in FIG. 1). As a result, a signal can then be sent to the ejector 38 in order to eject the case 14 from the conveyor 16 when the case 14 passes into a position acknowledged by the positioning sensor 40. Although not shown in FIG. 1, each of the elements associated with the apparatus 10 is interconnected together by way of the programmable logic controller 42.

In FIG. 1, the first ram 22 includes a cylinder 46 having a piston 48 extending outwardly therefrom. An arm 50 is pivotally connected to the piston 48. A microsensor 52 is connected to cylinder 46 so as to sense the amount of movement of the piston 48 within the cylinder 46. Although hydraulics or pneumatics can be used within the concept of the present invention, it is believed that the preferred embodiment of the present invention would be in the form of a pneumatic cylinder 46. Pneumatic conduit 54 can extend to the microsensor 52 so as to allow air to be introduced into the cylinder 46 for the actuation of the piston 48. The arm 50 is pivotally connected to the end of the piston 48. In a first position, the arm 50 is generally oriented vertically. The arm 50 has an abutment member 56 at an upper end thereof. In the upright position, the arm 50 will allow the case 14 to pass thereover. When the cylinder 46 is actuated, the piston 48 will be drawn inwardly of the cylinder 46 so as to cause the arm 50 to pivot in the manner shown by the arm illustrated in broken line fashion. The abutment member 56 will apply a force against the wall 24 so as to urge the wall 24 outwardly. If there is a crack, such as crack 58 in the case 14, then the wall 24 will move outwardly in the form of broken line wall 44. As a result, the sensor 52 will indicate that the piston 48 has moved inwardly beyond a predetermined limit and, as a result, the wall 24 has deflected outwardly beyond a desired amount. As a result, a signal can be transmitted to the programmable logic controller 42 to indicate that the case 14 is defective. Ultimately, the arm 50 will be retracted so as to allow the case 14 to move forward along conveyor 16 to the ejector 38. Programmable logic controller 42 will send a signal to the ejector 38 so as to remove the case 14 from the conveyor 16. Positioning sensor 40 will also send a signal to the programmable logic controller 42 to indicate when the case 14 has arrived at its desired position along conveyor 16 adjacent to the ejector 28.

The ejector 38 is also in the form of a pneumatic ram having a cylinder 60 and piston 62. In a first position, the piston 62 is suitably retracted so as to allow the case 14 to move in a proper position adjacent thereto. In a second position, the piston 62 will extend outwardly from the cylinder 60 so as to force the case 14 off of the conveyor 16.

In the present invention, the conveyor 16 can take a wide variety of configurations. Preferably, the cases 12 and 14 will ride along within angle irons 64 and 66. A suitable motive force, such as a chain, belt, linkage, or other type of the conveyor, will cause the cases 12 and 14 to move along within the angle irons 64 and 66.

When the positioning sensor 32 senses that the forward wall 24 of the case 14 is located in a desired position, the positioning brakes 28, in the form of pneumatic rams 68 and 70, will cause the piston to extend upwardly and to abut the interior of the back wall 30 of case 14. As a result, the case 14 will stop in its desired position while the conveyor 16 continues to move along. Since the case 12 is also moving along the conveyor 16, it is necessary for separator brakes 34, in the form pneumatic rams 72 and 74, to extend the pistons upwardly and engage the interior of the back wall 36 of the case 12. This will cause the case 12 to also stop along the conveyor 16 and to be suitably spaced from the case 14. Programmable logic controller 42 will control the operation of the pneumatic rams 68, 70, 72 and 74.

The present invention also includes a second ram 26 positioned adjacent to the bottom 20 of the case 14. In the present invention, it is important to detect the integrity of the bottom 20 of each of the cases 12 and 14. If the bottom is cracked, then the case 14 will not have sufficient integrity to withstand the loads imparted thereto. In order to detect whether a crack has occurred on the bottom 14, the second ram 26 is particularly configured for acting on the bottom 14.

In FIG. 1, it can be seen that a crack 76 has occurred in the bottom 20 of case 14. The second ram 26 also includes a cylinder 78 having a piston 80 extending outwardly therefrom. A microsensor 82 is connected to the cylinder 78 so as to determine the relative movement of the piston 80 with respect to the cylinder 78. A pneumatic conduit 84 connects with the cylinder 78 so as to supply air pressure to the ram 26. A roller 86 is positioned at the end of the piston 80 opposite the cylinder 78. When the ram 28 is actuated, the piston 80 will move outwardly so that the roller 86 exerts a force downwardly upon the bottom 20 of case 14. If the piston 80 deflects too greatly outwardly, then the microsensor 82 will send a signal to the programmable logic controller 42 that a crack has occurred in the bottom 20 of case 14. As a result, the case 14 will be properly ejected by the ejector 38 when it moves into position adjacent the positioning sensor 40.

The present invention is able to carry out the inspection, detection and ejection of the particular cases in a relatively rapid manner. It is believed that the test can be properly carried out within 0.5 seconds. As a result, there will not a great deal of a backup along the conveyor 16. The present invention, when the limits associated with the rams 22 and 26 are properly set, will accurately determine whether the case 12 and 14 have suitable structural integrity for further use. The apparatus 10 of the present invention can be a separate apparatus in the factory or can be part of a line operation where the cases will continue to passed to another location, such as for cleaning and/or filling. When the inspection has been completed and the case 14 shows adequate structural integrity, the ram 68 and 70 will cause the case 14 to be released therefrom by retracting the pistons associated therewith downwardly into the respective cylinders of the rams 68 and 70. At the same time, rams 72 and 74 will also release case 12 so that the conveyor 16 can move the case 12 into its desired position for testing. Positioning sensor 32 will then detect when the forward wall 88 is in its desired position for testing.

Referring to FIG. 2, there is a shown a front view of the apparatus 10 of the present invention. In particular, it is noted that a frame 90 serves to the support the conveyor 16 in a desired manner. The programmable logic control panel 42 is affixed to the upper frame portion 92. The ejector 38 is positioned on one side of the upper frame portion 92. The arm 50, along with the abutment member 56, are illustrated in an upright position generally positioned between the rams 68 and 70 of the positioning brakes 28. The first ram 22 is generally located centrally of the conveyor 16 and within the interior of the upper frame 92. The second ram 26 is positioned at the top cross-member 94 of the upper frame portion 92. Roller 86 extends downwardly from the cross member 94 so as to interact with the case positioned therebelow.

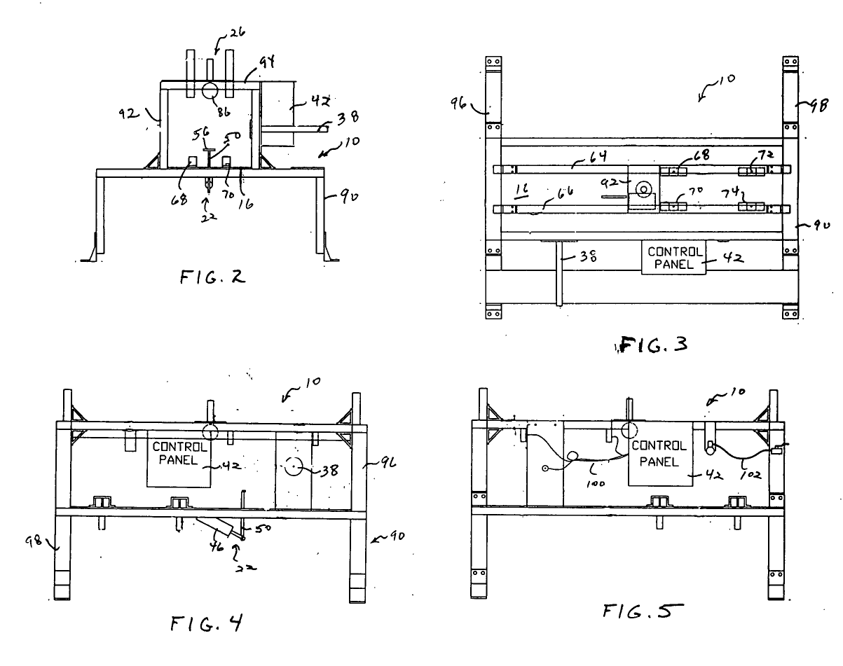

FIG. 3 shows the plan view of the apparatus 10 of the present invention. In particular, it can be seen that the angle irons 64 and 66 associated with conveyor 16 are positioned between the end members 96 and 98 of frame 90. The ejector 38 is positioned at one end of the frame 90. The control 42 is positioned generally centrally along the length of the frame 90. The positioning brakes 68 and 70 are positioned adjacent to the upper frame 92. The separator brakes 72 and 74 are positioned adjacent to the end 98 of frame 90.

FIG. 4 shows one side view of the device 10 of the present invention. In FIG. 4, it can be seen that the cylinder 46 of the first ram 22 is positioned centrally along the length of the frame 90. The arm 50 is pivotally connected to the piston extending outwardly of cylinder 46 and also is pivotally connected to the frame 90 so as to provide the proper range of motion for the arm 56.

FIG. 5 shows the device 10 of the present invention. In particular, in FIG. 5, it can be seen how the control panel 42 is connected by various lines 100 and 102 to the various elements associated with the operation of the present invention.

The foregoing disclosure and description of the invention is illustrative and explanatory thereof. Various changes in the details of the illustrated construction and in the steps of the described method can be made within the scope of the appended claims without departing from the true spirit of the invention. The present invention should only be limited by the following claims and their legal equivalents.

1. An apparatus for detecting a cracked or broken case comprising:
a frame;
a conveyor means mounted on said frame, said conveyor means for moving the case along said frame; and
a first ram means affixed to said frame, said first ram means for applying a force onto a surface of a wall of the case.

2. The apparatus of claim 1, further comprising:
a sensor means cooperative with said first ram means, said sensor means for detecting when the surface of the wall of the case has deflected beyond a desired amount.

3. The apparatus of claim 2, further comprising:
ejection means affixed to said frame and cooperative with said conveyor means for ejecting the case from said conveyor means when the wall of the case has deflected beyond the desired amount.

4. The apparatus of claim 1, further comprising:
a second ram means affixed to said frame and positioned in a different location on said frame from said first ram means, said second ram means for applying a force onto another surface of the case.

5. The apparatus of claim 1, said first ram means comprising:
a pneumatic ram having a cylinder affixed to said frame, said pneumatic ram having a piston extending outwardly therefrom; and
an arm pivotally connected to said piston and pivotally connected to said frame.

6. The apparatus of claim 5, said piston being movable between a first position and a second position relative to said cylinder, said first position causing said arm to be positioned away from the wall of the case, said second position urging the wall of the case outwardly.

7. The apparatus of claim 6, further comprising:
a sensor means connected to said cylinder and cooperative with said piston, said sensor means for determining when said second position is beyond a desired limit of movement.

8. The apparatus of claim 4, said second ram means comprising:
a pneumatic ram having a cylinder affixed to said frame and a piston extending outwardly of said cylinder, said piston being movable between a first position and a second position relative to said cylinder, said first position positioning said piston away from said another surface of the case, said second position urging against said another surface of the case.

9. The apparatus of claim 8, said piston having a roller rotatably positioned at an end of the said piston opposite said cylinder.

10. The apparatus of claim 3, said ejection means comprising:
a pneumatic ram having a cylinder affixed to said frame, said pneumatic ram having a piston extending outwardly therefrom, said piston being movable between a first position and a second position relative to said cylinder, said first position causing said piston to be positioned away from the case, said second position urging against the case so as to separate the case from said conveyor means.

11. The apparatus of claim 1, further comprising:
a positioning means affixed to said frame, said positioning means for fixing a position of the case relative to said frame.

12. The apparatus of claim 11, further comprising:
a separating means affixed to said frame in spaced relation to said positioning means, said separating means for spacing another case from the case on the conveyor means when said positioning means fixed the position of the case.

13. A method of detecting a cracked or broken case comprising:
fixing a position of the case, the case having an open side and a closed side with a plurality of walls extending therebetween;
applying a force against one of the plurality of walls such that the wall deflects; and
determining whether the deflection of the wall is beyond a desired amount.

14. The method of claim 13, said step of applying the force comprising:
positioning a surface of a ram against the wall of the case; and
actuating said ram such that said surface of said ram urges against the wall of the case.

15. The method of claim 14, said step of determining comprising:
sensing an amount of movement of said surface of said ram.

16. The method of claim 15, said ram having a pneumatic cylinder mounted in a fixed position, said ram having a piston extending outwardly of said cylinder; said ram having an arm pivotally connected to, said piston, said step of actuating the ram comprising:
retracting said piston within said cylinder such that said arm pivots outwardly, said arm having said surface thereon urging against said wall.

17. The method of claim 13, further comprising:
forming a frame having a conveyor thereon; and
conveying the case along the frame prior to said step of fixing the position of the case.

18. The method of claim 17, said step of fixing the position comprising:
actuating a pneumatic ram such that a piston of the ram extends through said open side and abuts one of said plurality of walls so as to stop a movement of the case relative to said conveyor.

19. The method of claim 13, further comprising:
ejecting the case when the deflection of the wall is beyond the desired amount.

20. The method of claim 13, further comprising:
applying another force against said closed side of said case, such that said closed side deflects; and
determining whether the deflection of said closed side is beyond a predetermined limit.

21. The method of claim 17, further comprising:
placing the case on said conveyor such that said open side faces said conveyor.
